(19) United States
(12) Patent Application Publication
(10) Pub. No.: US 2009/0135364 A1
(43) Pub. Date: May 28, 2009

(54) SINGLE-SIDED PRINTED CIRCUIT BOARD AND LIQUID CRYSTAL DISPLAY HAVING THE SAME

(75) Inventors: Jung-Sun LEE, Gwangju-si (KR); Soong-Yong JOO, Seongnam-si (KR); Hyoung-Sik MOON, Seoul (KR); Dong-Yub LEE, Siheung-si (KR)

Correspondence Address: CANTOR COLBURN, LLP, 20 Church Street, 22nd Floor, Hartford, CT, 06103, US

(73) Assignee: Samsung Electronics Co., Ltd., Suwon-si (KR)

(21) Appl. No.: 12/258,777

(22) Filed: Oct. 27, 2008

(30) Foreign Application Priority Data
Nov. 28, 2007 (KR) 10-2007-0122245

(51) Int. Cl. G02F 1/133; H01R 12/00

(52) U.S. Cl. 349/149; 439/65

(57) ABSTRACT

A single-sided PCB employing a board-to-board (“B2B”) connecter and an LCD having the single-sided PCB. The single-sided printed circuit board connected to a liquid crystal display panel driving unit includes a base plate; and a plurality of lines formed on one surface of the base plate. The plurality of lines include a first line group and a second line group formed at both sides of the first line group, the second line group having a narrower line width than that of the first line group.

This application claims priority to Korean Patent application No. 10-2007-0122245, filed on Nov. 28, 2007, and all the benefits accruing therefrom under 35 U.S.C. § 119, the contents of which in its entirety are herein incorporated by reference.

### BACKGROUND OF THE INVENTION

1. Field of the Invention

The present invention relates to a single-sided printed circuit board and a liquid crystal display having the same, and more particularly, to a single-sided printed circuit board employing a board-to-board (“B2B”) connecter and a liquid crystal display having the single-sided printed circuit board.

2. Description of the Related Art

In general, the application range of a liquid crystal display (“LCD”) has been extended because of its lightweight, thin profile, low-power drive, full color and high resolution characteristics. Currently, the LCD is used in desktop personal computers, notebook personal computers, personal digital assistants (“PDAs”), telephones, televisions (“TVs”), audio/video devices, and the like. In the LCD, a desired image is displayed on a liquid crystal display panel in which the amount of light to be transmitted is controlled according to video signals applied to a plurality of control switches arranged in a matrix. In addition, the LCD includes a liquid crystal display panel driving unit, such as a source driver and a gate driver in the form of integrated circuits (“ICs”), for causing a desired image to be displayed on the liquid crystal display panel. The liquid crystal display panel driving unit is connected to a control unit including a time controller (“T-Con”) and the like.

A conventional LCD has an additional printed circuit board (“PCB”) formed with a connector in order to connect the LCD panel driving unit to the control unit. In the conventional PCB, a zero insertion force (“ZIF”) connector, a board-to-board (“B2B”) connector or the like is used as the connector. The ZIF connector is applied to a single-sided PCB, and the B2B connector is applied to a double-sided PCB. However, it is not possible to implement the B2B connector with the single-sided PCB because lines connected to the B2B connector are entangled in view of characteristics of the connector. Therefore, when a user orders a PCB employing a B2B connector, a double-sided PCB should be used to employ the B2B connector, resulting in increased production costs.

### BRIEF SUMMARY OF THE INVENTION

The present invention is conceived to solve the aforementioned problems in the prior art, and is to provide a single-sided printed circuit board employing a board-to-board connecter and a liquid crystal display having the single-sided printed circuit board.

According to an aspect of the present invention, there is provided a single-sided printed circuit board (“PCB”) connected to a liquid crystal display (“LCD”) panel driving unit, which includes a base plate; and a plurality of lines formed on one surface of the base plate, wherein the plurality of lines include a first line group and a second line group formed at both sides of the first line group and has a narrower line width than that of the first line group.

The single-sided PCB may further include a third line that is formed outside of the second line group and has a broader line width than those of the first and second line groups.

The single-sided PCB may further include a connector connecting unit in a plurality of rows on the one surface of the base plate, wherein the plurality of lines are connected in parallel to the connector connecting unit. At least some of the plurality of lines may be formed between the plurality of rows of the connector connecting unit. The base plate may include a base portion connected to the LCD panel driving unit; and an extension portion extending from the base portion, wherein the connector connecting unit is formed on the extension portion. The connector connecting unit may be formed to extend in a direction substantially normal to a direction in which the extension portion extends.

The plurality of lines may be formed such that the sums of the line widths of lines distributed at one side and an opposite other side of the connector connecting unit are substantially the same. The single-sided PCB may further include a board-to-board (“B2B”) connector connected to the connector connecting unit.

According to another aspect of the present invention, there is provided an LCD including an LCD panel for displaying images thereon; an LCD panel driving unit for driving the LCD panel; and a single-sided PCB that is connected to the LCD panel driving unit to apply signals and includes a plurality of signal lines and a power line with a broader line width than those of the plurality of signal lines, wherein the power line is formed between the plurality of signal lines.

The single-sided PCB may include a base plate for use in forming the power line and the plurality of signal lines, the plurality of signal lines and the power line may be formed on one surface of the base plate, and the base plate may include a base portion connected to the LCD panel driving unit and an extension portion extending from the base portion.

The LCD may further include a connector connecting unit in a plurality of rows on one surface of the extension portion, and a B2B connector connected to the connector connecting unit, wherein the plurality of signal lines and the power line are connected to the connector connecting unit. The connector connecting unit may include first and second row connector connecting units, the plurality of signal lines may be connected to the respective first and second row connector connecting units, and the power line may be connected to the first row connector connecting unit of the connector connecting unit.

The LCD may further include a light source line connected to the second row connector connecting unit of the connector connecting unit. The LCD may further include a light source mounted on the base portion and connected to the light source line.

The LCD may further include a ground line formed at least one of between the signal lines and the power line and between the signal lines and the light source line. The ground line may include a plurality of ground lines, and at least some of the plurality of ground lines may be formed at least at a portion of an edge of the base plate.

At least some of the signal lines and light source line connected to the second row connector connecting unit may be formed between the first and second row connector connecting units. The first row connector connecting unit may be positioned closer to the base portion than the second row connector connecting unit.

The sums of the line widths of lines distributed at one side and an opposite other side of the connector connecting unit may correspond to each other. The LCD panel driving unit may be mounted in an integrated circuit (“IC”) type on the LCD panel.

### BRIEF DESCRIPTION OF THE DRAWINGS

Preferred embodiments of the present invention can be understood in more detail from the following description taken in conjunction with the accompanying drawings, in which:

FIG. 1 is a schematic plan view of a liquid crystal display (“LCD”) panel assembly according to a first exemplary embodiment of the present invention;

FIG. 2 is an enlarged schematic plan view of portion “A” in FIG. 1;

FIG. 3 is a schematic plan view of an LCD panel assembly according to a second exemplary embodiment of the present invention;

FIG. 4 is an enlarged schematic plan view of portion “B” in FIG. 3;

FIG. 5 is a schematic plan view of an LCD panel assembly according to a third exemplary embodiment of the present invention;

FIG. 6 is an enlarged schematic plan view of portion “C” in FIG. 5; and

FIG. 7 is a schematic exploded perspective view of an LCD according to an exemplary embodiment of the present invention.

### DETAILED DESCRIPTION OF THE INVENTION

The invention will now be described more fully hereinafter with reference to the accompanying drawings, in which exemplary embodiments of the invention are shown. The present invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including,” when used in this specification, specify the presence of stated features, regions, integers, steps, operations, elements and/or components, but do not preclude the presence or addition of one or more other features, regions, integers, steps, operations, elements, components and/or groups thereof.

Furthermore, relative terms, such as “lower” or “bottom” and “upper” or “top” may be used herein to describe one element's relationship to other elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on the “upper” side of the other elements. The exemplary term “lower” can, therefore, encompass both an orientation of “lower” and “upper,” depending upon the particular orientation of the figure. Similarly, if the device in one of the figures were turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning which is consistent with their meaning in the context of the relevant art and the present disclosure, and will not be interpreted in an idealized or overly formal sense unless expressly so defined herein.

Exemplary embodiments of the present invention are described herein with reference to cross section illustrations which are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes which result, for example, from manufacturing. For example, a region illustrated or described as flat may, typically, have rough and/or nonlinear features. Moreover, sharp angles which are illustrated may be rounded. Thus, the regions illustrated in the figures are schematic in nature and their shapes are not intended to illustrate the precise shape of a region and are not intended to limit the scope of the present invention.

Hereinafter, exemplary embodiments of the present invention will be described in further detail with reference to the accompanying drawings.

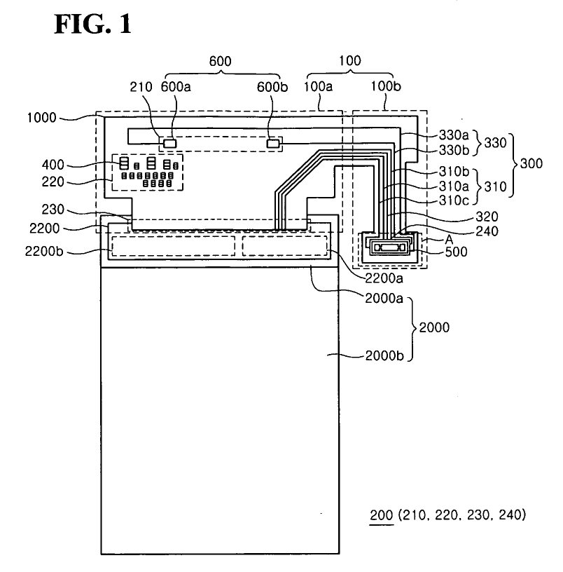

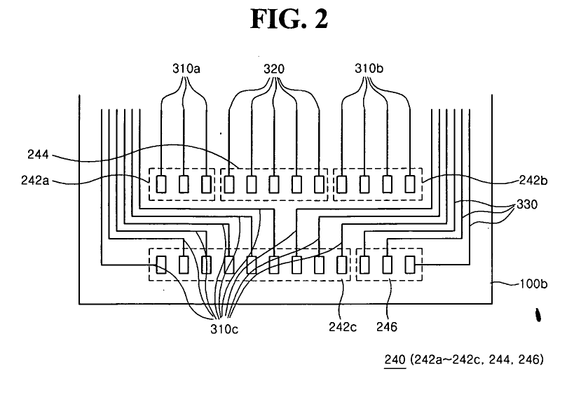

FIG. 1 is a schematic plan view of a liquid crystal display (“LCD”) panel assembly according to a first exemplary embodiment of the present invention. FIG. 2 is an enlarged schematic plan view of portion “A” in FIG. 1. A connector shown in FIG. 1 is omitted in FIG. 2.

As shown in FIGS. 1 and 2, the LCD panel assembly according to the first embodiment of the present invention includes an LCD panel 2000, an LCD panel driving unit 2200 for driving the LCD panel 2000, and a single-sided printed circuit board (“PCB”) 1000 connected to the LCD driving unit 2200.

The LCD panel 2000 includes a thin film transistor (“TFT”) substrate 2000a, a color filter substrate 2000b corresponding to the TFT substrate 2000a, and a liquid crystal layer (not shown) interposed between the TFT substrate 2000a and the color filter substrate 2000b. The LCD panel 2000 may further include polarization plates (not shown) respectively formed above the color filter substrate 2000b and below the TFT substrate 2000a.

The color filter substrate 2000b is a substrate having red (R), green (G) and blue (B) pixels, which are color pixels expressing predetermined colors when light passes therethrough, formed by means of a thin film process. A common electrode (not shown), which is a transparent conductive thin film made of a transparent conductor such as indium tin oxide (“ITO”) or indium zinc oxide (“IZO”), is formed on the entire surface of the color filter substrate 2000b.

The thin film transistor substrate 2000a is a transparent glass substrate on which thin film transistors (“TFTs”) and pixel electrodes are arranged substantially in a matrix. Data lines are connected to source terminals of the TFTs, and gate lines are connected to gate terminals thereof In addition, pixel electrodes (not shown), which are transparent electrodes made of a transparent conductive material, are connected to drain terminals of the TFTs. When electrical signals are input into the data lines and the gate lines, the respective TFTs are turned on or off, so that the electrical signals required for formation of pixels are applied to the drain terminals.

The LCD panel driving unit 2200 is used to drive the LCD panel 2000. The LCD panel driving unit 2200 can include a signal generating unit 2200a for generating signals for displaying images on the LCD panel 2000, and a signal applying unit 2200b for driving the LCD panel 2000 in accordance with signals generated by the signal generating unit 2200a. The LCD panel driving unit 2200 in this embodiment is of an IC type and can be formed in an exposed region of the TFT substrate 2000a.

The single-sided PCB 1000 applies signals to the LCD panel driving unit 2200, and includes a base plate 100 and a wiring unit 300, a connection unit 200, passive elements 400 and a connector 500, which are formed on one surface of the base plate 100.

The base plate 100 forms the wiring unit 300, a connector connecting unit 240 and a passive element connecting unit 220 and to support the passive elements 400 mounted on the passive element connecting unit 220. The base plate 100 may be formed in a film shape using a resin including polyimide, polyethylene terephtalate (“PET”) or the like. In this case, a protective layer (not shown) for protecting the wiring unit 300 formed on the base plate 100 may be formed. The base plate 100 can include a base portion 100a for use in forming the IC connecting unit 230, the passive element connecting unit 220 and a light source connecting unit 210, and an extension portion 100b extending from one side of the base portion 100a so as to form the connector connecting unit 240.

The wiring unit 300 connects the connector connecting unit 240 to the IC connecting unit 230, and can be formed on one surface of the base plate 100. In this case, the wiring unit 300 can include a signal line unit 310, a power line unit 320 and a light-source line unit 330.

The signal line unit 310 transmits signals, which have been applied to the connector connecting unit 240, to the LCD panel driving unit 2200. The signal line unit 310 can include first to third signal line units 310a to 310c each of which having a plurality of signal lines. In this embodiment, the signal line unit 310 can include a plurality of signal lines, and the plurality of signal lines can include data signal lines DAT0 to DAT7(not shown), a test signal line TE (not shown), a strobe signal write line WRX (not shown), a strobe signal read line RDX (not shown), a reset signal line RESX (not shown), a command determination signal line CSX (not shown) and a register selection signal line DCX (not shown).

The first signal line unit 310a includes the data signal lines DAT5 to DAT 7, and the second signal line unit 310b includes the strobe signal write line WRX for writing strobe signals, the strobe signal read line RDX for reading strobe signals and the reset signal line RESX for applying reset signals. The third signal line unit 310c includes the data signal lines DAT0 to DAT4, the command determination signal line CSX for determining the type of a signal applied to the data signal lines DAT0 to DAT7, and the register selection signal line DCX for selecting a register. In exemplary embodiments, the first to third signal line units 310a to 310c extend from the connector connecting unit 240 formed on one surface of the extension portion 100b to one surface of the base portion 100a to be connected to the LCD panel driving unit 2200, and are formed in parallel so as not to be entangled with one another. In this case, the power line unit 320 is formed between the first and second signal line units 310a and 310b so as to effectively utilize the space on the base plate 100 in exemplary embodiments.

Meanwhile, it has been described by way of example in this embodiment that the signal line unit 310 includes the data signal lines DAT0 to DAT7, the test signal line TE, the strobe signal write line WRX, the strobe signal read line RDX, the reset signal line RESX, the command determination signal line CSX and the register selection signal line DCX. However, the number and functions of such signal lines may vary depending on the type of the LCD panel driving unit 2200 in alternative embodiments.

The power line unit 320 applies power to the LCD panel driving unit 2200, and can include first and second power lines VDD Line and VDDI Line and first to third ground lines GND1 Line, GND2 Line and GND3 Line. The power line unit 320 may be formed between the first signal line unit 310a and the second signal line unit 310b.

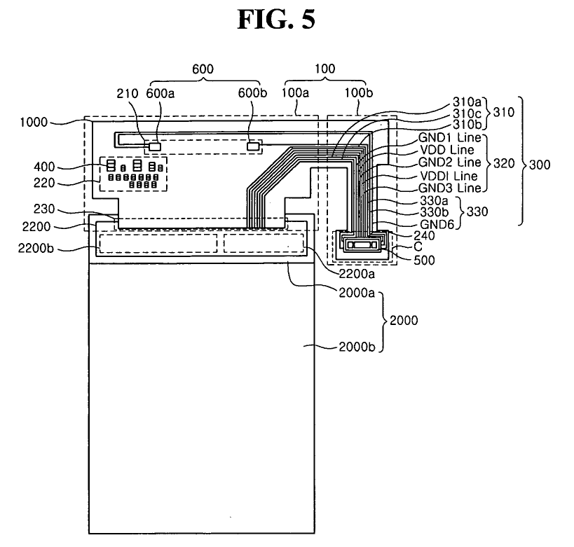

The light-source line unit 330 drives a light source 600, and can include first and second light-source lines 330a and 330b and a sixth ground line GND6 (not shown, but see FIG. 5). In this embodiment, the light source 600 includes two light emitting diodes (“LEDs”), i.e., first and second LEDs 600a and 600b, respectively, and the first and second light-source lines 330a and 330b are connected respectively to the first and second LEDs 600a and 600b, respectively.

The connection unit 200 connects the wiring unit 300 to the light source 600, the passive elements 400, the LCD driving unit 2200 and the connector 500. The connection unit 200 includes the connector connecting unit 240, the IC connecting unit 230, the passive element connecting unit 220 and the light source connecting unit 210.

The connector connecting unit 240 mounts the connector 500 thereon for making an electrical connection thereto. Referring to FIG. 2, the connector connecting unit 240 can include first to third signal line connecting units 242a to 242c connected to the first to third signal line units 310a to 310c, respectively, a power line connecting unit 244 connected to the power line unit 320 and a light-source line connecting unit 246 connected to the light-source line unit 330. The connector connecting unit 240 may include a plurality of contact pads formed by etching a portion of the protective layer of the base plate 100 and exposing a copper film therein to the outside so that pins formed in the connector 500 can be connected to the connector connecting unit 240. Such a plurality of contact pads can be connected to the connector 500. The connector connecting unit 240 in this embodiment can include two rows: a first row connector connecting unit having the first and second signal line connecting units 242a and 242b and the power line connecting unit 244 formed therein, and a second row connector connecting unit spaced apart by a predetermined distance from the first row connector connecting unit and having the third signal line connecting unit 242c and the light-source line connecting unit 246 formed therein. The connector 500 connects a control unit (not shown) for controlling the LCD panel driving unit 2200 and the light source 600 to the connector connecting unit 240. The connector 500 can include a board-to-board (“B2B”) connector. In exemplary embodiments, the B2B connector has two rows of a plurality of pins to connect to the connector connecting unit 240, and is laterally mounted such that the direction of the rows of the connector pins intersects with the direction in which the extension portions 100b extends from the base portion 100a. The plurality of pins of the B2B connector are arranged in two rows to correspond to the first and second row connector connecting units in exemplary embodiments.

The IC connecting unit 230 connects the LCD panel driving unit 2200 to the signal line unit 310 and the power line unit 320, and can be formed by etching the protective layer in a region of the base plate 100 to connect to the LCD panel driving unit 2200 and expose a copper film therein to the outside.

The passive element connecting unit 220 has the passive elements 400 mounted thereon, and can be connected to the IC connecting unit 230. In this case, the passive element connecting unit 220 is also formed by etching the protective layer in a region of the base plate 100 to connect to the passive elements 400 and expose a copper film therein to the outside. Upon formation of the signal line unit 310, the passive element connecting unit 220 is advantageously formed at one end region of the base portion 100a of the base plate 100 spaced apart farthest or most distal from the extension portion 100b of the base plate 100 so as to secure a maximum space on the base portion 100a. That is, the passive element connecting unit 220 is preferably disposed such that the signal line unit 310 can be formed between the passive element connecting unit 220 and the extension portion 100b of the base plate 100. In this case, the passive elements 400 are mounted on the passive element connecting unit 220 to control a voltage required in the LCD panel driving unit 2200. The passive elements 400 can include elements such as resistors, capacitors and the like, for example, but is not limited thereto.

The light source connecting unit 210 has the light source 600 mounted thereon, and the first and second LEDs 600a and 600b mounted on the light source connecting unit 210 are respectively connected to the first and second light-source lines 330a and 330b of the light-source line unit 330. It will be apparent to those skilled in the pertinent art that the present invention is not limited thereto. That is, when it is difficult to connect the light source 600 directly to the light source connecting unit 210, the light source connecting unit 210 and the light source 600 can be connected by an additional flexible PCB.

The single-sided PCB 1000 with the aforementioned structure according to this embodiment can be manufactured by effectively arranging the connector connecting unit 240. That is, since there is a narrow space between the first and second row connector connecting units, the power line connecting unit 244 is formed in the first row connector connecting unit, as illustrated in FIG. 2. Thus, the first row connector connecting unit, which is a first row of the connector connecting unit 240, includes the first and second signal line connecting units 242a and 242b and the power line connecting unit 244, and the power line connecting unit 244 is formed between the first and second signal line connecting units 242a and 242b.

In order to effectively use the space on the extension portion 100b, the first row connector connecting unit is disposed such that the lines of the signal line unit 310 are equally divided in a lateral direction. At this time, the lines of the signal line unit are formed to have a minimum line width, and lines requiring a high voltage generally needs a line width larger than that of lines requiring a low voltage. Since the width of lines of the power line unit 320 for supplying power is larger than the width of the lines for transmitting signals, due to such a difference in voltage, the power line unit 320 is positioned at the center of the first row connector connecting unit. That is, in order to equally divide the signal line unit 310 connected to the first row connector connecting unit, the signal line connecting unit 242 of the first row connector connecting unit is divided into the first and second signal line connecting units 242a and 242b, and the power line connecting unit 244 is formed between the first and second signal line connecting units 242a and 242b, thereby causing the power line unit 320 to be formed between the first and second signal line units 310a and 310b.

Further, the second row connector connecting unit, which is a second row of the connector connecting unit 240, includes the third signal line connecting unit 242c and the light-source line connecting unit 246. In exemplary embodiments, the first and second signal line connecting units 242a and 242b and the power line connecting unit 244 of the first row connector connecting unit are formed in a region of the extension portion 100b close to the base portion 100a, and the third signal line connecting unit 242c and light-source line connecting unit 246 of the second row connector connecting unit are spaced apart by a predetermined distance from the first row connector connecting unit and formed at an end of the extension portion 100b remote from the base portion 100a. For such an arrangement of the connector connecting unit 240, it is preferred that the arrangement of pins in the LCD panel driving unit 2200 correspond to that of the connector connecting unit 240. That is, the arrangement of the pins in the IC-type LCD panel driving unit 2200 corresponds to the arrangement of the connector connecting unit 240 such that the lines of the wiring unit 300 for connecting the connector connecting unit 240 to the LCD panel driving unit 2200 are not entangled with each other. Since there is a narrow space between the first and second row connector connecting units, signal lines having the smallest line width among the signal lines are advantageously arranged in the second row connector connecting unit.

Further, the first and second signal line units 310a and 310b and the power line unit 320 connected to the first and second signal line connecting units 242a and 242b, respectively, and the power line connecting unit 244 formed in the first row connector connecting unit advantageously extend in a direction opposite to the second row connector connecting unit.

A portion of the third signal line unit 310c connected to the third signal line connecting unit 242c formed in the second row connector connecting unit is formed to pass between the first and second row connector connecting units and to subsequently pass outside of one side of the first row connector connecting unit, i.e., outside of the first row connector connecting unit close to the first signal line connecting unit 242a. The rest of the third signal line unit 310c and the light-source line unit 330 connected to the light source connecting unit 210 are formed to pass between the first and second row connector connecting units and to subsequently pass outside of the other side of the first row connector connecting unit, i.e., outside of the first row connector connecting unit close to the second signal line connecting unit 242b. It will be apparent that the entire third signal line unit 310c may be formed outside of the one side of the first row connector connecting unit depending on the line width of the lines of the wiring unit 300 formed between the first and second row connector connecting units and outside of the one and the other sides of the first row connector connecting unit.

The sum of the line widths of the portion of the third signal line unit 310c passing outside of the one side of the first row connector connecting unit is substantially the same as the sum of the line widths of the rest of the third signal line unit 310c passing outside of the other side of the first row connector connecting unit and the line width of the light-source line unit 330 in exemplary embodiments. The aforementioned arrangement of the wiring unit 300 may vary depending on the type of the LCD panel driving unit 2200 connected to the wiring unit 300. In exemplary embodiments, for effective use of a space between the first and second row connector connecting units and spaces outside of the one and the other sides of the first row connector connecting unit, the sum of line widths of the lines of the second signal line unit 310b formed outside of the one and the other sides of the first row connector connecting unit are almost the same as the sum of the line widths of the lines of the light-source line unit 330 regardless of the number of lines in each of the light-source line unit 330 and the third signal line unit 310 connected to the second row connector connecting unit.

As described above, in the LCD panel assembly according to this embodiment, the lines of the connector connecting unit 240 are arranged in a plurality of rows, and the plurality of lines are divided and arranged outside of the one and the other sides of the connector connecting unit 240 depending on the line widths of the lines of the wiring unit 300, so that the lines of the wiring unit 300 formed outside of the one and the other sides of the connector connecting unit 240 have substantially the same sum of line widths of the lines. Accordingly, the single-sided PCB 1000 having one base plate 100 is manufactured and then mounted on an LCD panel, thereby reducing manufacturing costs of the LCD panel assembly.

Next, an LCD panel assembly according to a second embodiment of the present invention will be described with reference to the accompanying drawings. Some descriptions of the following LCD panel assembly of the second embodiment overlapping with those of the aforementioned LCD panel assembly of the first embodiment will be omitted or briefly made.

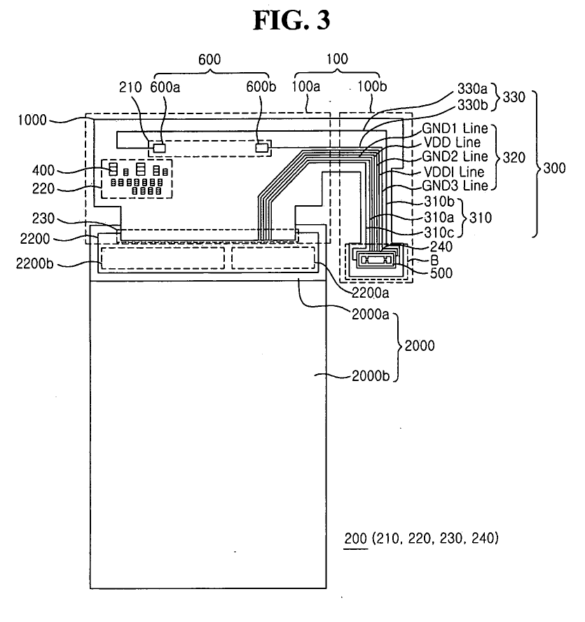

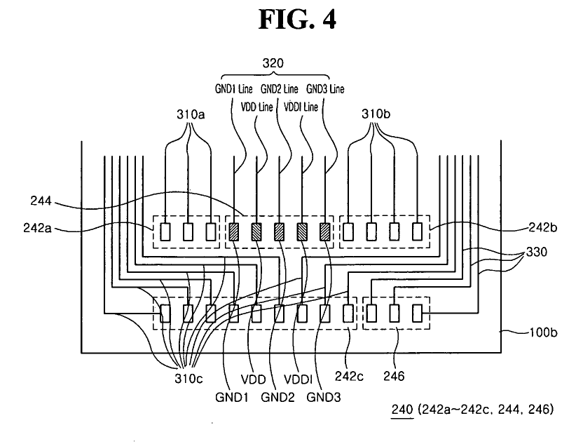

FIG. 3 is a schematic plan view of an LCD panel assembly according to a second exemplary embodiment of the present invention. FIG. 4 is an enlarged schematic plan view of portion “B” in FIG. 3. A connector shown in FIG. 3 is omitted in FIG. 4, as in FIG. 2 for clarity.

As shown in FIGS. 3 and 4, the LCD panel assembly according to the second embodiment of the present invention includes an LCD panel 2000 for displaying images thereon, an LCD panel driving unit 2200 for driving the LCD panel 2000, and a single-sided PCB 1000 connected to the LCD panel driving unit 2200.

The single-sided PCB 1000 applies signals to the LCD panel driving unit 2200. The single-sided PCB 1000 includes a connection unit 200 having a light source connecting unit 210, a connector connecting unit 240, an IC connecting unit 230 and a passive element connecting unit 220; a wiring unit 300 for connecting the connector connecting unit 240 to the light source connecting unit 210 and the IC connecting unit 230; passive elements 400 mounted on the passive element connecting unit 220; a connector 500 mounted on the connector connecting unit 240; and a base plate 100 for supporting and fixing the connection unit 200, the wiring unit 300, the passive elements 400 and the connector 500. The wiring unit 300 includes a signal line unit 310, a power line unit 320 and a light-source line unit 330.

The connector 500 is mounted on the connector connecting unit 240 for making an electrical connection thereto. The connector connecting unit 240 can include first to third signal line connecting units 242a to 242c connected to first to third signal line units 310a to 310c, respectively, a power line connecting unit 244 connected to the power line unit 320, and a light-source line connecting unit 246 connected to the light-source line unit 330. The power line connecting unit 244 can include first and second power line connecting units VDD and VDDI, and first to third ground line connecting units GND1 to GND 3.

The power line unit 320 applies power to the LCD panel driving unit 2200. The power line unit 320 can include first and second power lines VDD Line and VDDI Line connected to the first and second power line connecting units VDD and VDDI, respectively, and first to third ground lines GND1 Line, GND2 Line and GND3 Line connected to the first to third ground line connecting units GND1 to GND3, respectively. In this embodiment, the power line unit 320 can be formed between the first and second signal line units 310a and 310b in the same manner as described in the first embodiment (FIGS. 1 and 2) of the present invention.

The single-sided PCB 1000 according to this embodiment is a high-density board having narrow spacing between the lines of the wiring unit 300, and crosstalk may be generated by electromagnetic induction/electrostatic induction in such parallel lines close to one another. Particularly, since there is a large difference in voltage between the signal line unit 310 and the power line unit 320, it is very likely that an interference phenomenon occurs.

Therefore, for the power line unit 320 in this embodiment, in order to minimize an interference phenomenon between the first and second power lines VDD Line and VDDI Line due to a voltage difference and an interference phenomenon between the first and second power lines VDD Line and VDDI Line and the first and second signal line units 310a and 310b, ground lines are positioned between the first and second power lines VDD Line and VDDI Line and between the first and second signal line units 310a and 310b. Accordingly, in the single-sided PCB 1000 according to this embodiment, the second ground line GND2 Line is formed between the first and second power lines VDD Line and VDDI Line. Further, the first ground line GND1 Line is formed between the first power line VDD Line and the first signal line unit 310a, and the third ground line GND3 Line is formed between the second power line VDDI Line and the second signal line unit 310b. In order to arrange the lines of the wiring unit 300 as described above, a first row connector connecting unit is formed in order of the first signal line connecting unit 242a, the first ground line connecting unit GND1, the first power line connecting unit VDD, the second ground line connecting unit GND2, the second power line connecting unit VDDI, the third ground line connecting unit GND 3, and the second signal line connecting unit 242b. The plurality of line connecting units are connected to the plurality of lines corresponding thereto.

By forming the ground lines as described above, noise radiated from the first and second signal line units 310a and 310b and the power line unit 320 can flow into the closest ground line. That is, noise radiated from the first signal line unit 310a can flow into the first ground line GND1 Line, and noise radiated from the first power line VDD Line can flow into the first ground line GND1 Line or the second ground line GND2 Line. Noise radiated from the second power line VDDI Line can flow into the second ground line GND2 Line or the third ground line GND3 Line, and noise radiated from the second signal line unit 310b can flow into the third ground line GND3 Line.

Although three ground lines, i.e., the first to third ground lines GND1 Line, GND2 Line and GND3 Line, are used as the ground lines in this embodiment, the present invention is not limited thereto. That is, one or two ground lines may be provided as the ground lines. Alternatively, three or more ground lines may be provided as the ground lines. The one or more ground lines may be formed between the first signal line unit 310a and the first power line VDD Line, between the first power line VDD Line and the second power line VDDI Line, or between the second power line VDDI Line and the second signal line unit 310b.

As described above, in the LCD panel assembly according to this embodiment, a ground line is formed between a signal line and a power line, thereby minimizing an interference phenomenon between the signal line and the power line. Further, in the LCD panel assembly according to this embodiment, a ground line is also formed between respective signal lines or power lines, thereby minimizing an interference phenomenon between the respective signal lines or power lines.

Next, an LCD panel assembly according to a third embodiment of the present invention will be described with reference to the accompanying drawings. Some descriptions of the following LCD panel assembly of the third embodiment overlapping with those of the LCD panel assemblies of the first and second embodiments will be omitted or briefly made.

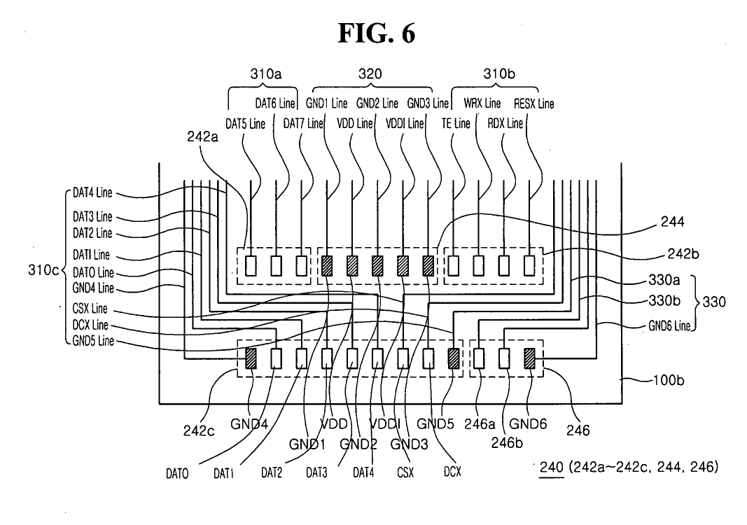

FIG. 5 is a schematic plan view of an LCD panel assembly according to a third exemplary embodiment of the present invention. FIG. 6 is an enlarged schematic plan view of portion “C” in FIG. 5. A connector shown in FIG. 5 will be omitted in FIG. 6, as in FIGS. 2 and 4 for clarity.

As shown in FIGS. 5 and 6, the LCD panel assembly according to the third embodiment of the present invention includes an LCD panel 2000, an LCD panel driving unit 2200 for driving the LCD panel 2000, and a single-sided PCB 1000 connected to the LCD panel driving unit 2200.

The single-sided PCB 1000 applies signals to the LCD panel driving unit 2200. The single-sided PCB 1000 includes a connection unit 200 including a light source connecting unit 210, a connector connecting unit 240, an IC connecting unit 230 and a passive element connecting unit 220; a wiring unit 300 for connecting the connector connecting unit 240 to the light source connecting unit 210 and the IC connecting unit 230; passive elements 400 mounted on the passive element connecting unit 220; a connector 500 mounted on the connector connecting unit 240; and a base plate 100 for supporting and fixing the connection unit 200, the wiring unit 300, the passive elements 400 and the connector 500. The wiring unit 300 includes a signal line unit 310, a power line unit 320 and a light-source line unit 330. The power line unit 320 in this embodiment is formed in the same manner as the aforementioned embodiments.

The signal line unit 310 transmits signals, which have been applied to the connector connecting unit 240, to the LCD panel driving unit 2200. The signal line unit 310 can include first to third signal line units 310a to 310c each of which has a plurality of signal lines. At this time, the third signal line unit 310c can include zeroth to fourth data signal lines DAT0 to DAT4 Lines, a command determination signal line CSX Line, a register selection signal line DCX Line, and fourth and fifth ground lines GND4 Line and GND5 Line.

The light-source line unit 330 supplies power to LEDs and can include a first light-source line 330a, a second light-source line 330b and a sixth ground line GND6 Line. At this time, the sixth ground line GND6 Line may be connected commonly to first and second LEDs 600a and 600b, or may be connected to the first LED 600a as shown in FIG. 5.

The connector connecting unit 240 includes a power connecting unit 244, a first signal line connecting unit 242a and a second signal line connecting unit 242b, which are provided in a first row connector connecting unit, and a third signal line connecting unit 242c and a light-source line connecting unit 245, which are provided in a second row connector connecting unit. Further, the third signal line connecting unit 242c includes fourth and fifth ground line connecting units GND4 and GND5, zeroth to fourth data signal line connecting units DAT0 to DAT4, a command determination signal line connecting unit CSX and a register selection signal line connecting unit DCX. The light-source line connecting unit 245 includes first and second light-source line connecting units 246a and 246b and a sixth ground line connecting unit GND6. At this time, the second row connector connecting unit is spaced apart by a predetermined distance from the first row connector connecting unit in the same manner as described in the aforementioned embodiments. Moreover, the third signal line connecting unit 242c and the light-source line connecting unit 246, which are provided in the second row connector connecting unit, are arranged in order of the fourth ground line connecting unit GND4, the zeroth to fourth data signal line connecting units DAT0 to DAT4, the command determination signal line connecting unit CSX, the register selection signal line connecting unit DCX, the fifth ground line connecting unit GND5, the first light-source line connecting unit 246a, the second light-source line connecting unit 246b and the sixth ground line connecting unit GND6.

In the single-sided PCB 1000 according to this embodiment, the fourth and sixth ground lines GND4 Line and GND6 Line connected to the second row connector connecting unit are disposed at both respective outermost sides of an extension portion 100b of the base plate 100 so as to increase the strength of an edge of the single-sided PCB 1000.

To this end, the fourth ground line connecting unit GND4 is disposed at one end of the second row connector connecting unit, and the sixth ground line connecting unit GND6 is disposed at the other opposite end of the second row connector connecting unit. Accordingly, the fourth ground line GND4 Line connected to the fourth ground line connecting unit GND4 is disposed at one edge of the extension portion 100b, and the sixth ground line GND6 Line connected to the sixth ground line connecting unit GND6 is disposed at the other opposite edge of the extension portion 100b. The fourth ground line GND4 Line connected to the fourth ground line connecting unit GND4 passes outside of one side of the first row connector connecting unit at one side of the second row connector connecting unit. The sixth ground line GND6 connected to the sixth ground line connecting unit GND6 passes outside of the other side of the first row connector connecting unit at the other side of the second row connector connecting unit.

In the single-sided PCB 1000 according to this embodiment, all spaces remaining after other lines except the fourth and sixth ground lines GND4 Line and GND6 Line have been formed are allocated to the fourth and the sixth ground lines GND4 Line and GND6 Line. That is, the area of the line widths of the fourth and the sixth ground lines GND4 Line and GND6 Line formed at least at outermost edges of the extension portion 100b and a base portion 100a is maximized among those of the line widths of any other lines, thereby increasing the strength of the edge of the single-sided PCB 1000 as much as possible.

As described above, in the single-sided PCB 1000 according to this embodiment, ground lines having a broader line width, i.e., the fourth and sixth ground lines GND4 Line and GND6 Line, are formed at least at certain edges of the extension portion 100b and the base portion 100a, e.g., outermost edges, so as to increase the strength of the edges of the single-sided PCB 1000, thereby preventing the single-sided PCB 1000 from being torn.

In the single-sided PCB 1000 according to this embodiment, the areas of the fourth and sixth ground lines GND4 Line and GND6 Line are maximized, thereby preventing the LCD panel 2000 and the LCD panel driving unit 2200 from being damaged due to electrostatic discharge (“ESD”) and electromagnetic interference (“EMI”). That is, since static electricity generally occurs by surface charges of a charged object, it is easily generated with respect to an object having a larger surface area as compared with its weight. Therefore, static electricity and electromagnetic waves generated when the line widths of ground lines are maximized to increase the areas of the ground lines as described above can be grounded through the fourth and sixth ground lines GND4 Line and GND6 Line having broader line widths.

Meanwhile, in the single-sided PCB 1000 according to this embodiment, a ground line, i.e., the fifth ground line GND5 Line, is formed between a third signal line unit and a light-source line unit, thereby minimizing an interference phenomenon between the third signal line unit and the light-source line unit.

Next, an LCD according to the present invention will be described with reference to the accompanying drawings. Some descriptions of the following LCD of the present invention overlapping with the above descriptions will be omitted or briefly made.

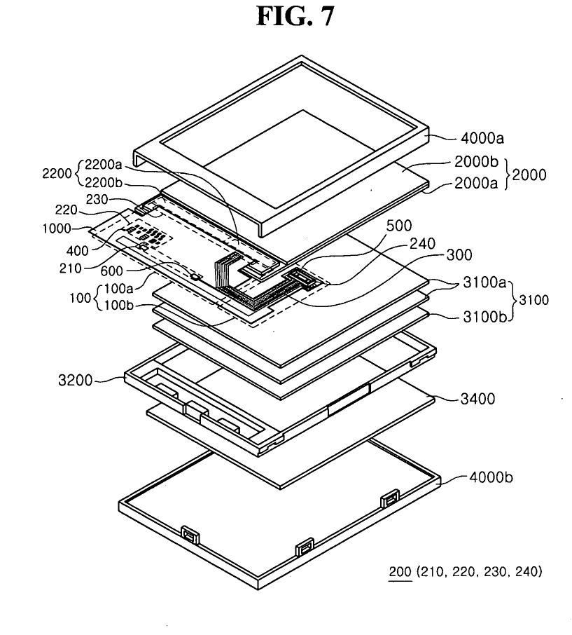

FIG. 7 is a schematic exploded perspective view of an LCD according to an exemplary embodiment of the present invention.

As shown in FIG. 7, the LCD according to the present invention includes an LCD panel assembly and a backlight unit assembly for supplying light to the LCD panel assembly. At this time, the LCD of the present invention may further include a receiving member for accommodating and protecting the LCD panel assembly and the backlight unit assembly.

The LCD panel assembly includes an LCD panel 2000, an LCD panel driving unit 2200 for driving the LCD panel 2000, and a single-sided PCB 1000 connected to the LCD panel driving unit 2200.

The single-sided PCB 1000 applies signals to the LCD panel driving unit 2200. The single-sided PCB 1000 includes a connection unit 200 having a light source connecting unit 210, a connector connecting unit 240, an IC connecting unit 230 and a passive element connecting unit 220; a wiring unit 300 having a signal line unit, a power line unit and a light-source line unit so as to connect the connector connecting unit 240 to the light source connecting unit 210 and the IC connecting unit 230; passive elements 400 mounted on the passive element connecting unit 220; a connector 500 mounted on the connector connecting unit 240; and a base plate 100 for supporting and fixing the connection unit 200, the wiring unit 300, the passive elements 400 and the connector 500. The base plate 100 can include a base portion 100a for use in forming the IC connecting unit 230, the passive element connecting unit 220 and the light source connecting unit 210; and an extension portion 100b extending from one side of the base portion 100a so as to form the connector connecting unit 240.

In the single-sided PCB 1000 with the aforementioned structure according to the present invention, the wiring unit 300 is formed by distributing a plurality of lines such that the sum of the line widths of lines formed outside of one side of the connector connecting unit 240 is almost identical with that of the line widths of lines formed outside of the other side of the connector connecting unit 240. That is, the signal line unit having a large number of lines with a narrow line width is formed outside of the one side of the connector connecting unit 240, and the light-source line unit having a small number of lines with a broad line width is formed outside of the other side of the connector connecting unit 240, so that the sum of the line widths of the lines of the wiring unit 300 formed outside of the one side of the connector connecting unit 240 is almost identical with that of the line widths of the lines of the wiring unit 300 formed outside of the other side of the connector connecting unit 240. In this case, the power line connecting unit 244 is advantageously formed at the center of the connector connecting unit 240. The lines of the wiring unit 300 connected to the connector connecting unit 240 are arranged not to be entangled with one another, thereby replacing a conventional double-sided PCB with a single-sided PCB and reducing manufacturing costs.

In addition, a ground line is formed between a signal line and a power line, thereby preventing an interference phenomenon between the signal line and the power line. Moreover, a ground line with a broad line width is formed at least at a portion of an edge of the base portion 100a and an edge of the extension portion 100b, thereby preventing the single-sided PCB 1000 from being torn.

The backlight unit assembly may include a light guide plate 3400 and optical sheets 3100 formed above and below the light guide plate 3400. The backlight unit assembly may further include a mold frame 3200 for accommodating and fixing the light guide plate 3400 and the optical sheets 3100.

The light guide plate 3400 is used to convert a point light source, which emits light from an LED which is a light source 600, into a surface light source. The light guide plate 3400 may be made of a transparent material with a certain refractive index, e.g., polymethylmethacrylate (“PMMA”), polyolefin, polycarbonate or the like for example, but is not limited thereto. At this time, the base plate 100 is bent such that the LED is positioned at a side of the light guide plate 3400, and light emitting from the LED is incident on the side of the light guide plate 3400 and exits upward through the light guide plate 3400.

The optical sheets 3100 are positioned above the light guide plate 3400 to ensure the uniform luminance distribution of light exiting from the light guide plate 3400. The optical sheets 3100 include a diffusion sheet 3100b and prism sheets 3100a. The diffusion sheet 3100b directs light incident from the LED 600 toward the front of the LCD panel 2000, and diffuses light to have uniform distribution over a broad range so that the LCD panel 2000 is irradiated with the light. The prism sheets 3100a function to allow angled-incident light of the light incident on the prism sheets 3100a to exit substantially normal thereto, e.g., vertically, as illustrated in FIG. 6.

As described above, according to the present invention, it is possible to provide a single-sided PCB capable of employing a B2B connector by forming lines between respective ones of a plurality of rows of the connector connecting unit, and an LCD having the PCB.

Further, according to the present invention, it is possible to provide a single-sided PCB capable of employing a B2B connector to reduce manufacturing costs, and an LCD having the PCB.

Moreover, according to the present invention, it is possible to provide a single-sided PCB in which a ground line is formed between a signal line and a power line to prevent an interference phenomenon between the signal line and the power line, and an LCD having the PCB.

In addition, according to the present invention, it is possible to provide a single-sided PCB in which a ground line with a broad line width is formed at an edge of the PCB to minimize tear of a base plate, and an LCD having the PCB.

Furthermore, according to the present invention, it is possible to provide a single-sided PCB in which a power line is disposed at the center of an extension portion of a base plate to minimize the area of the extension portion, and an LCD having the PCB.

Although the present invention has been described in connection with the exemplary embodiments and the accompanying drawings, it can be understood that those skilled in the art can make various modifications and changes thereto without departing from the technical spirit of the present invention defined by the appended claims.

What is claimed is:

1. A single-sided printed circuit board connected to a liquid crystal display panel driving unit, the printed circuit board comprising:
a base plate; and
a plurality of lines formed on one surface of the base plate,
wherein the plurality of lines include a first line group and a second line group formed at both sides of the first line group, the second line group having a narrower line width than that of the first line group.

2. The single-sided printed circuit board as claimed in claim 1, further comprising a third line formed outside of the second line group, the third line having a broader line width than those of the first and second line groups.

3. The single-sided printed circuit board as claimed in claim 1, further comprising a connector connecting unit in a plurality of rows on the one surface of the base plate,
wherein the plurality of lines are connected in parallel to the connector connecting unit.

4. The single-sided printed circuit board as claimed in claim 3, wherein at least some of the plurality of lines are formed between the plurality of rows of the connector connecting unit.

5. The single-sided printed circuit board as claimed in claim 4, wherein the base plate comprises:
a base portion connected to the liquid crystal display panel driving unit; and
an extension portion extending from the base portion,
wherein the connector connecting unit is formed on the extension portion.

6. The single-sided printed circuit board as claimed in claim 5, wherein the connector connecting unit is formed to extend in a direction substantially normal to a direction in which the extension portion extends.

7. The single-sided printed circuit board as claimed in claim 3, wherein the plurality of lines are formed such that the sums of the line widths of lines distributed at one side and an opposite other side of the connector connecting unit are substantially the same.

8. The single-sided printed circuit board as claimed in claim 3, further comprising a board-to-board connector connected to the connector connecting unit.

9. A liquid crystal display comprising:
a liquid crystal display panel for displaying images thereon;
a liquid crystal display panel driving unit for driving the liquid crystal display panel; and
a single-sided printed circuit board connected to the liquid crystal display panel driving unit to apply signals, the single-sided printed circuit board including a plurality of signal lines and a power line with a broader line width than those of the plurality of signal lines,
wherein the power line is formed between the plurality of signal lines.

10. The liquid crystal display as claimed in claim 9, wherein the single-sided printed circuit board comprises a base plate for use in forming the power line and the plurality of signal lines,
the plurality of signal lines and the power line are formed on one surface of the base plate, and
the base plate comprises a base portion connected to the liquid crystal display panel driving unit and an extension portion extending from the base portion.

11. The liquid crystal display as claimed in claim 10, further comprising:
a connector connecting unit in a plurality of rows on one surface of the extension portion, and
a board-to-board connector connected to the connector connecting unit,
wherein the plurality of signal lines and the power line are connected to the connector connecting unit.

12. The liquid crystal display as claimed in claim 11, wherein the connector connecting unit comprises first and second row connector connecting units,
the plurality of signal lines are connected to the respective first and second row connector connecting units, and
the power line is connected to the first row connector connecting unit of the connector connecting unit.

13. The liquid crystal display as claimed in claim 12, further comprising a light source line connected to the second row connector connecting unit of the connector connecting unit.

14. The liquid crystal display as claimed in claim 13, further comprising a light source mounted on the base portion and connected to the light source line.

15. The liquid crystal display as claimed in claim 12, further comprising a ground line formed at least one of between the signal lines and the power line and between the signal lines and the light source line.

16. The liquid crystal display as claimed in claim 15, wherein the ground line comprises a plurality of ground lines, and
at least some of the plurality of ground lines are formed at least at a portion of an edge of the base plate.

17. The liquid crystal display as claimed in claim 12, wherein at least some of the signal lines and light source line connected to the second row connector connecting unit are formed between the first and second row connector connecting units.

18. The liquid crystal display as claimed in claim 17, wherein the first row connector connecting unit is positioned closer to the base portion than the second row connector connecting unit.

19. The liquid crystal display as claimed in claim 11, wherein the sums of the line widths of lines distributed at one side and an opposite other side of the connector connecting unit are substantially the same.

20. The liquid crystal display as claimed in claim 9, wherein the liquid crystal display panel driving unit is mounted in an integrated chip type on the liquid crystal display panel.
